(19) United States
(12) Patent Application Publication
(10) Pub. No.: US 2002/0093484 A1
(43) Pub. Date: Jul. 18, 2002

(54) Method and system for use of a pointing device with moving images

(76) Inventors: Michael Skala, Yokneam Moshava (IL); Tal Davidson, Haifa (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/004,270

(22) Filed: Dec. 6, 2001

Related U.S. Application Data
(60) Provisional application No. 60/251,493, filed on Dec. 7, 2000.

(51) Int. Cl. G09G 5/08

(52) U.S. Cl. 345/163

(57) ABSTRACT

A system and method allows altering the display of an image stream, which may be produced for example by a swallowable capsule. A workstation accepts images acquired by the capsule and displays the images on a monitor as a moving image. A user, through for example a scrolling wheel of a pointing device, sends signals to the workstation which alter the display of the moving image. The changes in the display may include, for example, altering the display direction of the moving image, and altering the resolution or position of a captured image from the moving image.

### PRIOR APPLICATIONS

This application claims the benefit of prior provisional U.S. application Ser. No. 60/251,493 entitled “Method and System for Use of a Mouse Wheel With Video Files” filed on Dec. 7, 2000.

### FIELD OF THE INVENTION

The present invention relates to a method and system for using a pointing device to manipulate a moving image of a series of captured images.

### BACKGROUND OF THE INVENTION

When viewing a moving image, for example a moving image which may be used for medical diagnosis, the viewer may desire to scroll, manually or at a constant or variable speed, through the frames of the moving image. A user may desire to zoom or rotate captured images from the moving image, in order to study certain portions or frames.

For example, U.S. Pat. No. 5,604,531, assigned to the common assignee of the present application and incorporated herein by reference, teaches an in vivo imaging system which is carried by a swallowable capsule The imaging system captures and transmits images of the GI tract to an external recording device while the capsule passes through the GI lumen. Such an in vivo imaging system provides a platform from which moving or still images of a GI tract may be viewed. Large numbers of images may be collected for viewing. For example, the images may be combined in sequence, and a moving image of, for example, 40 minutes in length, may be presented to the user.

A need exists for a system or method, which enables a user to scroll through the frames of a moving image or zoom and rotate captured images in an easy and convenient manner.

### SUMMARY OF THE INVENTION

An exemplary embodiment of the present invention provides a system and method for scrolling or otherwise manipulating an image stream preferably being produced by an in vivo imaging device such as a swallowable capsule. A workstation accepts images acquired by the capsule and displays the images on a monitor as a moving image. A user, for example, by rolling the wheel of a pointing device or manipulating a Joystick may alter, for example, the display direction of the moving

### BRIEF DESCRIPTION OF THE DRAWINGS

The present invention will be understood and appreciated more fully from the following detailed description taken in conjunction with the drawings in which:

FIG. 1 shows a schematic diagram of an in vivo imaging system according to one embodiment of the present invention;

FIG. 2 is a representation of an image and a set of scrolling abilities displayed on the monitor of FIG. 1, according to one embodiment of the present invention; and

FIG. 3 depicts a flowchart for altering the display direction of the moving image, according to one embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

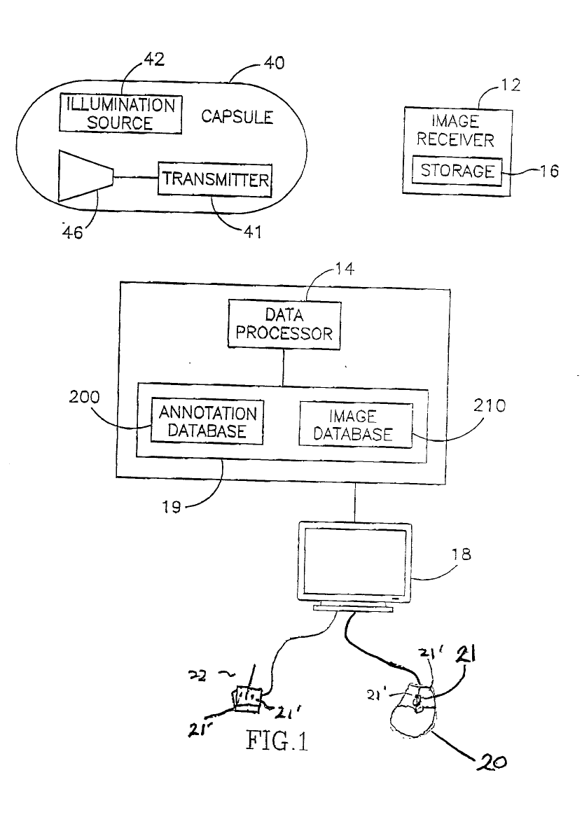

Reference is made to FIG. 1, which shows a schematic diagram of an in vivo imaging system according to one embodiment of the present invention. In an exemplary embodiment, the system comprises a capsule 40 having an imager 46, for capturing images, an illumination source 42, for illuminating the body lumen, and a transmitter 41, for transmitting image and possibly other information to a receiving device. An optical system (not shown), including, for example, lenses or mirrors, may aid in focusing reflected light onto the imager 46. The capsule 40 is swallowed by a patient and preferably traverses the patient's GI tract.

Preferably, located outside the patient's body in one or more locations, are an image receiver 12, preferably including an antenna or antenna array, an image receiver storage unit 16, a data processor 14, a data processor storage unit 19, an image monitor 18 for displaying, inter alia, the images recorded by the capsule 40, and a pointing device 20 with, for example, a scrolling wheel 21. Preferably, the pointing device 20 includes buttons, such as mouse buttons 21′ or a button operated by pressing down on the wheel 21. Other pointing devices may be included, such as a joystick 22 including buttons 21′. Joystick 22 is preferably a conventional joystick, but may, in addition, include other pointing devices.

Preferably, the image receiver 12 and the image receiver storage unit 16 are small and portable, and are worn on the patients body during recording of the images. Data processor storage unit 19 includes an image database 210. The image capture and/or image display system may be of different configurations. In an exemplary embodiment the image capture and display system may be those described by U.S. Pat. No. 5,604,531 to Iddan, but other systems may be used.

Preferably, data processor 14, data processor storage unit 19, monitor 18 and a pointing device 20 with a scrolling wheel 21, and/or a joystick 22, are part of a personal computer or workstation which includes standard components such as processor 14, a memory, a disk drive, and input-output devices, although alternate configurations are possible.

Data processor 14 may include any standard data processor, such as a microprocessor, multiprocessor, accelerator board, or any other serial or parallel high performance data processor. Image monitor 18 is preferably a conventional video display, but may, in addition, be any other device capable of providing image or other data. Pointing device 20 with a scrolling wheel 21, is preferably a conventional wheel mouse, but may, in addition, be any other pointing device such as a ball, a trackball, a toggle, or a button accepting direction information. Furthermore, the pointing device may be, for example, other pointing devices such a ball, a trackball, a toggle, or a button accepting direction information. The pointing device may be, for example, wireless. In alternate embodiments, display devices for displaying moving images other than a workstation may be used.

Preferably, the imager 46 is a suitable CMOS camera, such as a “camera on a chip” type CMOS imager specified by Given Imaging Ltd. of Israel and designed by Photobit Corporation of Calif., USA. In alternate embodiments, the imager 46 may be, for example, a GCD. The illumination source 42 may be, for example, a light emitting diode.

In operation, imager 46 captures images and sends data representing the images to transmitter 41, which transmits images to image receiver 12 using, for example, electromagnetic radio waves. In alternate embodiments other imagers may be used; for example an imager included in an endoscope. In alternate embodiments the imager 46 and the image receiver 12 may be connected through other systems, for example using a wire. Image receiver 12 transfers the image data to image receiver storage unit 16. After a certain period of time of data collection, the image data stored in storage unit 16 is sent to the data processor 14 or the data processor storage unit 19. For example, the image receiver storage unit 16 may be taken off the patients body and connected to the personal computer or workstation which includes the data processor 14 and data processor storage unit 19 via a standard data link, e.g., a serial or parallel interface of known construction. The image data is then transferred from the image receiver storage unit 16 to the image database 210 within data processor storage unit 19. Data processor 14 may analyze the data and a provides the analyzed data to the image monitor 18, where a health professional views the image data. Data processor 14 operates software (not shown) which, in conjunction with basic operating software such as an operating system and device drivers, controls the operation of data processor 14. Preferably, the software controlling data processor 14 includes code written in the C++ language, but may be implemented in a variety of known methods.

The image data collected and stored may be stored indefinitely, transferred to other locations, or manipulated or analyzed. A health professional may use the images to diagnose pathological conditions of the GI tract, and, in addition, the system may provide information about the location of these pathologies. While, using a system where the data processor storage unit 19 first collects data and then transfers data to the data processor 14, the image data is not viewed in real time, other configurations allow for real time viewing.

The image monitor 18 presents the image data, preferably in the form of still and moving pictures, and in addition may present other information. In an exemplary embodiment, the various categories of information are displayed in windows. Multiple monitors may be used to display image and other data.

Preferably, the in vivo imager system collects a series of still images as it traverses the GI tract. The images may be later presented as a stream of images or a moving image of the traverse of the GI tract. The in vivo imager system may collect a large volume of data, as the capsule 40 may take several hours to traverse the GI tract, and may record images at a rate of, for example, two images every second, resulting in the recordation of thousands of images. The image recordation rate (or frame capture rate) may be varied.

Preferably, the image data recorded and transmitted by the capsule 40 is digital color image data, although in alternate embodiments other image formats may be used. In an exemplary embodiment. each frame of image data includes 256 rows of 256 pixels each, each pixel including bytes for color and brightness, according to known methods. For example, in each pixel, color may be represented by a mosaic of four sub-pixels, each sub-pixel corresponding to primaries such as red, green, or blue (where one primary is represented twice). The brightness of the overall pixel is recorded by a one byte (Le., 0-255) brightness value. Preferably, images are stored sequentially in data processor storage unit 19. The stored data is comprised of one or more pixel properties, including color and brightness. Other image formats may be used.

While, preferably, information gathering, storage and processing are performed by certain units, the system and method of the present invention may be practiced with alternate configurations. For example, the components gathering image information need not be contained in a capsule, but may be contained in any other vehicle suitable for traversing a lumen in a human body, such as an endoscope, stent, catheter, needle etc.

Preferably, data processor storage unit 19 stores a series of images recorded by a capsule 40. The images the capsule 40 records as it moves through a patients GI tract may be combined consecutively to form a moving image. This moving image may be displayed in a window on monitor 18. The moving image may be frozen to view one frame, speeded up, or reversed, and sections may be skipped, but any other method for viewing an image may be applied to the moving image. While the following discussion relates to the case where data from a capsule 40 is stored for later use, the system and method of the present invention may be used with systems allowing for real time viewing of other image data.

In an exemplary embodiment, the moving image is stored as a series of images in the image database 210. When viewing the moving image, the user is preferably presented with several windows on monitor 18. An image window provides the moving image, or still portions of that image. Such a window may include buttons or other controls which may alter the display of the image; for example, stop, play, pause, capture image, step, fast-forward, rewind, or other controls. Such controls may be activated by, for example, a joystick 22, a pointing device 20, or a pointing device 20 with a scrolling wheel 21. The display may be altered by using the scrolling wheel 21 of the pointing device 20 or by using a joystick 22, with or without the use of the buttons or other controls in the software. A timeline window (not shown) may provide a timeline, an indication of the total time elapsed for the moving image and may provide other information, such as the total time of the moving image.

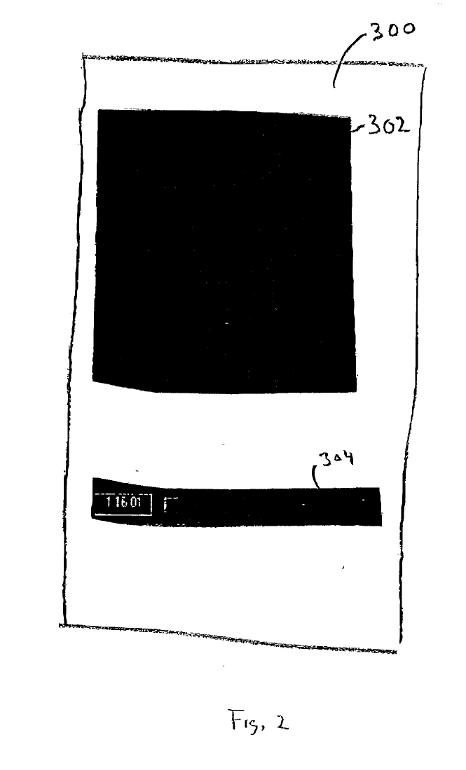

FIG. 2 is a representation of an image and a set of scrolling abilities displayed on the monitor of FIG. 1, according to one embodiment of the present invention. Referring to FIG. 2, the image window 300 displays the moving image 302, or still portions of the moving image 302. Controls 304 (preferably in combination with pointing device 20, scrolling wheel 21, or joystick 22) may alter the display of the moving image 302. Preferably, controls 304 include functionality such as play, stop, pause, forward, and backwards; other sets of functionality may be used. In one embodiment, moving the scrolling wheel 21 back and forth allows altering of the moving image display direction.

In an exemplary embodiment of the present invention, the display of the moving image may be altered manually or at a variable speed by using the wheel 21 of a pointing device 20. In alternate embodiments, other methods, such as by using a joystick 22, may be used.

Altering the display manually (e.g., moving the wheel 21 one step or click, or movement of a set distance of the wheel) may cause the movement of one frame or a set number of frames of the moving image. Preferably, while the user is viewing a moving image, the user firsts pauses or halts the display using, for example, a pause button displayed on the monitor or a button on the pointing device. This enables the display to be moved individual frames. After the pause in display, the user users the pointing device, such as the wheel 21, to move the moving picture display backwards or forwards. In certain modes or embodiments, such as the “variable” mode discussed below, a pause may not be required before using the pointing device to alter the image.

In addition, in a different mode, moving the wheel 21 a few steps or clicks may cause the movement of a set number of frames. The speed of the movement is preferably controlled by the speed of rolling the wheel 21. Alternatively, altering the display of images at a constant or variable speed can be achived by adopting different movements or positions of the wheel in order to cause the movement of the moving image at various speeds in different directions. In one embodiment, moving between “manual” mode and “variable” mode may be achieved by, for example, a control on the screen, a button on a keyboard, or a control on a pointing device. In another embodiment, a system may be configured for either one or the other mode.

In one embodiment, the display of the moving image can be altered at a variable speed by, for example, positioning the pointer icon on the moving image (or on another area of the screen), clicking the wheel 21 and dragging the pointing device away from the clicking reference point on the screen to cause the movement of the series of moving images. The direction of the movement, reverse or forward, depends on the direction of dragging the pointing device 20 from the clicking reference point. The speed of the movement depends on the distance between the pointing device 20 and the clicking reference point.

The display of the moving image can be altered in a “ariable” manner by, for example, rolling the wheel 21 backward or forward to change the display direction of the moving image. Once the wheel is rolled forward, rolling backward stops the movement of the moving image, and vice versa. When the user moves the wheel a certain distance from a “center point” the moving image is displayed, where, preferably, the speed of display is based on the distance of the wheel position from the center point and the direction of display is based on the direction of the wheel position from the center point. Thus, the moving image may be displayed forward or backward at a variable speed (or stopped) using a simple wheel control. Preferably, the further the-wheel is moved from a center point, the greater the display speed.

In a different embodiment, the display of the moving image can be altered as described above by using a joystick 22. For example, a user may move the joystick 22 backward or forward from the center point of the joystick to change the display direction of the moving image. Once the stick of the joystick 22 is pushed forward, pulling the stick backward will stop the movement of the moving image, and vice versa. The moving image may be displayed forward or backward at a variable speed (or stopped) using the joystick 22. Preferably, the further the joystick 22 is pushed or pulled from a center point, the greater the display speed.

In alternate embodiments, the pointing device may control other functions, such as zooming or rotating images. In an exemplary embodiment, when in a certain mode, the user may click (or click and hold) and hold the wheel 21 of the pointing device 20 (or similarly use joystick 22 or another pointing device) to cause the moving image, or a frame of the moving image, to rotate. In one embodiment, clicking (e.g., depressing) the scrolling wheel 21 and dragging the pointing device 20 may rotate the captured image clockwise or counterclockwise, depending on the dragging direction. In other embodiments, rotation may be achieved in other manners.

While viewing a portion of the moving image, the user may wish to zoom a captured image 302. In one embodiment, rolling the scrolling wheel 21 may zoom in and out the captured image 302, depending on the rolling direction. The user may wish to view the moving image in a variable speed. Clicking the scrolling wheel 21 or another button or control, and moving the pointing device 20 away from the clicking reference point on the screen may cause the software to alter the display direction (e.g., reverse or forward) of the moving image at a variable speed, depending on the distance between the pointer icon of the pointing device 20 and the clicking reference point. Rewinding or forwarding the moving image preferably depend on the location of the pointing device 20 in relation to the clicking point.

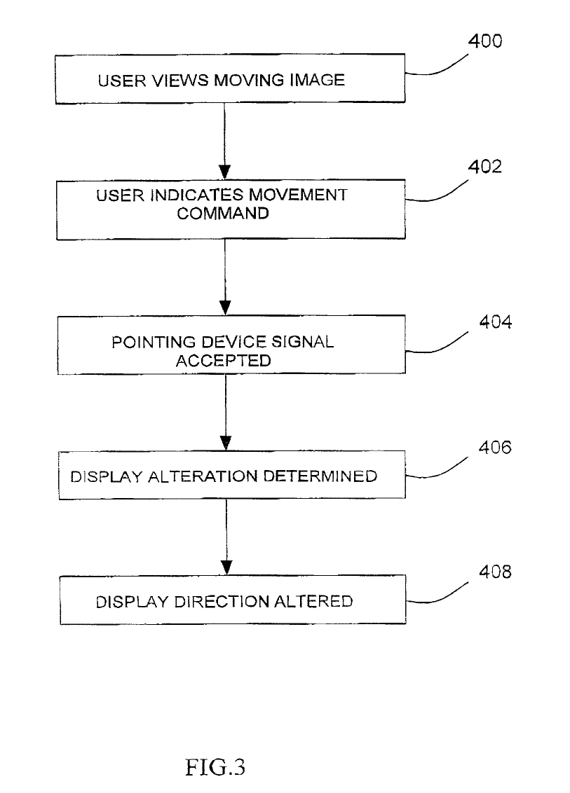

FIG. 3 depicts a flowchart for altering the display direction of the moving image, according to one embodiment of the present invention.

In step 400, the user views the moving image. The moving image may be displayed as discussed above.

In step 402, the user indicates a movement command for the image display through a pointing device. In one embodiment, the pointing device is a scrolling wheel 21, and the user rolls the scrolling wheel 21. The user may first pause the display before indicating a movement command, In alternate embodiments, the display need not be paused, for example, in an embodiment where a pointing device controls a relative speed and direction of display.

In step 404, the display device, such as the workstation displaying the moving image, accepts signals from the pointing device, through known methods. In one embodiment, the pointing device is a wheel 21. In alternate embodiments, the pointing device may be other devices.

In step 406, the display device determines if, and how, the display direction should be altered. In an exemplary embodiment, if the scrolling wheel 21 is moved a certain amount, the display device determines that the display should be moved. The direction and amount of the movement determines the direction and amount of frames that the moving image is moved.

In step 408, the display direction altered and the moving image is altered (e.g., rewound or forwarded).

In alternate embodiments, other series of steps may be used.

It will be appreciated by persons skilled in the art that the present invention is not limited by what has been particularly shown and described hereinabove. Rather the scope of the invention is defined by the claims that follow:

1. A method for observing an image stream, the method comprising:
accepting images acquired by a vehicle disposed within a body lumen;
displaying the images on a monitor in the form of a moving image;
accepting a signal from a wheel; and
altering the display of the moving image according to the signal.

2. The method of claim 1, wherein moving the wheel a certain distance from a center point causes the moving image to be displayed at a certain speed.

3. The method of claim 1, wherein moving the wheel a certain distance from a center point causes the moving image to be displayed in a certain direction.

4. The method of claim 1, wherein movement of a set distance of the wheel causes a different frame of the moving image to be displayed.

5. The method of claim 1, wherein movement of a set distance of the wheel represents a single movement of the moving image.

6. The method of claim 1, wherein the moving image can be displayed in variable speed.

7. The method of claim 1, wherein a signal is accepted through a scrolling wheel of a pointing device.

8. The method of claim 1, wherein the wheel is a scrolling wheel.

9. The method as in claim 1, wherein the vehicle is a capsule.

10. The method as in claim 1 wherein the images are images from a gastrointestinal tract.

11. A system for observing an image stream, the system comprising:
a processor displaying images acquired by a vehicle disposed within a body lumen in the form of a moving image; and
a wheel for accepting a signal from a user; wherein the processor accepts signals regarding the operation of the wheel and alters the display of the images accordingly.

12. The system of claim 11, wherein moving the wheel a certain distance from a center point causes the moving image to be displayed at a certain speed.

13. The system of claim 11 wherein moving the wheel a certain distance from a center point causes the moving image to be displayed in a certain direction.

14. The system of claim 11, wherein movement of a set distance of the wheel will cause a different frame of the moving image to be displayed.

15. The system of claim 11, wherein the moving image can be displayed in variable speed.

16. The system of claim 11, wherein a signal is accepted user through a scrolling wheel of a pointing device.

17. The system of claim 11, wherein the wheel is a scrolling wheel.

18. The system of claim 11, wherein the vehicle is a capsule.

19. The system of claim 11 wherein the images are images from a gastrointestinal tract.

20. A method for observing an image stream, the method comprising:
accepting images acquired by a vehicle disposed within a body lumen;
displaying the images on a monitor in the form of a moving image;
accepting a signal from via a scrolling wheel; and
altering the display of the moving image according to the signal accepted, wherein movement of a set distance of the wheel causes a different frame of the moving image to be displayed.

21. A method for observing an image stream, the method comprising:
accepting images acquired by a vehicle disposed within a body lumen;
displaying the images on a monitor in the form of a moving image;
accepting a signal from the user through a scrolling wheel of a pointing device; and
altering the display of the moving image according to the signal accepted from the user, wherein moving the wheel a certain distance from a center point causes the moving image to be displayed in a certain direction.

22. A system for observing an image stream, the system comprising:
a processor displaying images acquired by a vehicle disposed within a body lumen in the form of a moving image; and
a scrolling wheel for accepting a signal from a user; wherein the processor accepts signals regarding the operation of the wheel and alters the display direction of the images accordingly.

23. A system for observing an image stream, the system comprising:
a processor displaying images acquired by a vehicle disposed within a body lumen in the form of a moving image; and
a scrolling wheel of a pointing device for accepting a signal from a user;
wherein the processor accepts signals regarding the operation of the wheel and alters the display of the images accordingly wherein movement of a set distance of the wheel causes the moving image to display a different frame.

24. A method for observing an image stream, the method comprising:
accepting images acquired by a vehicle disposed within a body lumen;
displaying the images on a monitor in the form of a moving image;
accepting a signal via joystick; and
altering the display of the moving image according to the signal.

25. The method of claim 24, wherein moving the joystick a certain distance from a center point causes the moving image to be displayed at a certain speed.

26. The method of claim 24, wherein the moving the joystick a certain distance from a center point causes the moving image to be displayed in a certain direction.

27. The method as in claim 24, wherein the vehicle is a capsule.

28. The method as in claim 24 wherein the images are images from a gastrointestinal tract.

29. A system for observing an image stream, the system comprising:
a processor displaying images acquired by a vehicle disposed within a body lumen in the form of a moving image; and
a joystick for accepting a signal from a user; wherein the processor accepts signals regarding the operation of the joystick and alters the display of the images accordingly.

30. The system of claim 29, wherein moving the joystick a certain distance from a center point causes the moving image to be displayed at a certain speed.

31. The system of claim 29, wherein moving the joystick a certain distance from a center point causes the moving image to be displayed in a certain direction.

32. The system of claim 29, wherein the vehicle is a capsule.

33. The system of claim 29, wherein the images are images from a gastrointestinal tract.

34. A method for observing an image stream in variable speed, the method comprising:
accepting images acquired by a vehicle disposed within a body lumen;
displaying the images on a monitor in the form of a moving image;
accepting a signal from a joystick; and
altering the display of the moving image according to the signal.

35. A method for observing an image stream, the method comprising:
accepting images acquired by a vehicle disposed within a body lumen;
displaying the images on a monitor in the form of a moving image;
accepting a signal from a joystick; and
altering the display of the moving image according to the signal, wherein moving the joystick a certain distance from a center point causes the moving image to be displayed at a certain speed.

36. A system for observing an image stream in variable speed, the system comprising:
a processor displaying images acquired by a vehicle disposed within a body lumen in the form of a moving image;
a joystick for accepting a signal from a user; wherein the processor accepts signals regarding the operation of the joystick and alters the display direction of the images accordingly.

37. A system for observing an image stream, the system comprising:
a processor displaying images acquired by a vehicle disposed within a body lumen;
a monitor displaying the images in the form of a moving image; and
a joystick for accepting a signal; wherein the processor accepts signals regarding the operation of the joystick and alters the display of the images accordingly; and wherein moving the joystick a certain distance from a center point causes the moving image to be displayed at a certain speed.

38. A system for observing an image stream, the system comprising:
a processor means displaying images acquired by a vehicle disposed within a body lumen; and
a pointer means for accepting a signal from a user, wherein the processor accepts signals regarding the operation of the pointer means and alters the display direction of the images accordingly.
